(19) United States
(12) Patent Application Publication
(10) Pub. No.: US 2013/0334862 A1
(43) Pub. Date: Dec. 19, 2013

(54) ONE-PIECE SEAT BACK FRAME AND METHOD OF MANUFACTURING

(71) Applicant: Donald Ted Gibbs, Plymouth, MI (US)

(72) Inventor: Donald Ted Gibbs, Plymouth, MI (US)

(73) Assignee: Johnson Controls Technology Company, Holland, MI (US)

(21) Appl. No.: 13/977,352

(22) PCT Filed: Jan. 17, 2012
(86) PCT No.: PCT/US12/21551

§ 371 Date: Sep. 6, 2013

Related U.S. Application Data
(60) Provisional application No. 61/432,664, filed on Jan. 14, 2011.

(51) Int. Cl. B60N 2/68

(52) U.S. Cl. CPC B60N 2/68
USPC 297/452.18; 29/407.1

(57) ABSTRACT

A one-piece seat back frame for a seat assembly and method of forming includes a first member and an opposed second member spaced a predetermined distance apart. A third member extends between the first and second members. A fourth member is spaced a predetermined distance from the third member and has an initial predetermined dimension that is over-sized a predetermined amount to form an excisable slip plane portion, and a final predetermined dimension after the excisable portion is removed and free ends rejoined, so that the one-piece seat back frame can be adjusted prior to rejoining the free ends. The methodology removes the excisable portion, attaches a component to the frame, aligns the component by manipulating the fourth member free ends in the slip plane and rejoins the fourth member tree ends.

### CROSS REFERENCE TO RELATED APPLICATIONS

This application claims the benefit of and priority to U.S. Provisional Application No. 61/432,664, filed Jan. 14, 2011, which is incorporated herein by reference.

### BACKGROUND

The present disclosure relates generally to the field of vehicle seats and more particularly, to a one-piece seat back frame having an integral slip plane, method of manufacturing and assembling components thereto.

A vehicle seat back frame is typically made from a plurality of metal members arranged to form a structural frame. These members may be in the form of tubes and sheets that are generally formed into a particular shape, such as by bending, stamping piercing, drawing and welding or the like. During the manufacturing process the metal members are coupled together to form a rectangular frame. Further downstream the manufacturing process, a series of secondary operations are performed to further customize the seat back frame and add additional components, such as a recliner mechanism. These secondary operations are performed in several successive operations performed at different workstations, which complicates the manufacturing process and necessitates transfers from one workstation to the next. These secondary operations can be problematic to implement and pose a number of issues. For example, once a seat back frame has been formed it can be difficult to properly attach and align additional components, such as recliner mechanisms, to the seat back frame because the seat back frame has already been formed. These issues may be particularly evident when manufacturing a one-piece seat back frame. To rectify such misalignments, the seat back frame may need to be reworked or even scrapped which may increase manufacturing costs, reduce manufacturing efficiency, reduce seat back quality and performance, etc.

Thus, there is a need to provide a seat back frame and method of manufacturing and assembling the seat back frame that provides the ability to adjust the alignment of seat back components during the manufacturing process while maintaining the cost and mass benefits of a one-piece stamped seat back frame.

### SUMMARY

Accordingly, the present disclosure relates to a one-piece seat back frame for use in a vehicle seat assembly. The one-piece seat back frame includes a first member and an opposed second member spaced a predetermined distance apart, and a third member extending between the first member and second member. The one-piece seat back frame also includes a fourth member spaced a predetermined distance from the third member and extending between the first member and second member. The fourth member has an initial predetermined dimension that is over-sized a predetermined amount to form an excisable portion, and a final predetermined dimension after the excisable portion is removed and free ends rejoined so that the one-piece seat back frame can be adjusted prior to rejoining the free ends. The excisable middle portion facilitates manufacturing and customization of the seat back frame.

Also provided is a method of forming a one-piece seat back frame for use in a vehicle seat assembly. The method includes the step of providing a one-piece seat back frame having a first member, an opposed second member, a third member extending between the first member and second member and a fourth member spaced a predetermined distance from the third member and extending between the first member and second member. The fourth member has an initial predetermined dimension that is over-sized a predetermined amount to form an excisable portion. The method also includes the step of removing the excisable portion from the fourth member. The method further includes the steps of attaching a component to the one-piece seat back frame and adjusting the one-piece seat back frame to align the component by manipulating the free ends of the fourth member. The method still further includes the steps of rejoining the free ends of the fourth member, such that the fourth member has a final predetermined dimension after free ends are rejoined.

An advantage of the present disclosure is that the one-piece seat back frame and method of manufacturing the one-piece seat back frame enable relatively easy attachment, adjustment and realignment of other components thereto. Another advantage of the present disclosure is that the one-piece seat back frame can be further customized relatively easily. A further advantage of the present disclosure is that the one-piece seat back frame has a relatively low mass and is relatively inexpensive to manufacture.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is a perspective view of a vehicle.

FIG. 2 is a perspective view of a seat assembly for the vehicle of FIG. 1.

FIG. 3 is a front perspective view of a one-piece seat back frame for the seat assembly of FIG. 2.

FIG. 4 is a rear perspective view of the one-piece seat back frame of FIG. 3.

FIG. 5A is a front view of a one-piece seat back frame.

FIG. 5B is a cross sectional view of the one--piece seat back frame of FIG. 5A along the A-A line.

FIG. 6A is a front view of the one-piece seat back frame of FIG. 3 with the lower cross portion cut in two portions.

FIG. 6B is a cross sectional view of the one-piece seat back frame of FIG. 6A along the B-B line.

FIG. 7A is a front view of the one-piece seat back frame of FIG. 4 with the two portions of the lower cross member rejoined.

FIG. 7B is a cross sectional view of the one-piece seat back frame of FIG. 7A along the C-C line.

FIG. 8 is a flow chart of the methodology of customizing a one-piece seat back frame and attaching components thereto, according to an exemplary embodiment.

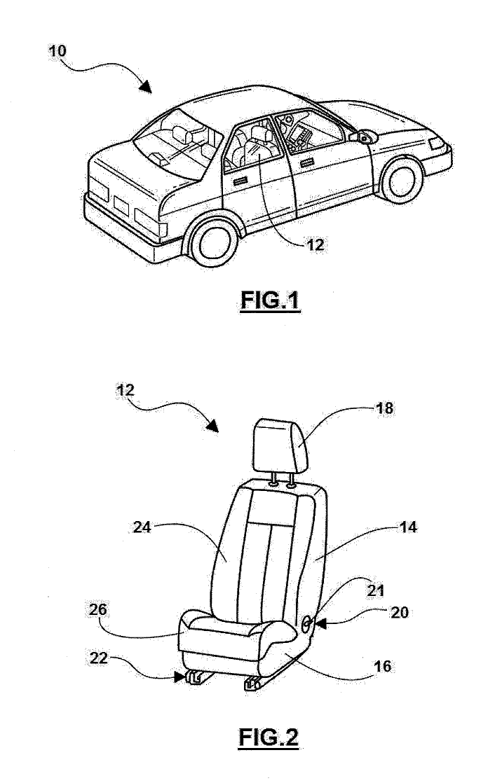

### DETAILED DESCRIPTION

Referring generally to the FIGURES and particularly to FIG, 1, a vehicle 10 is shown according to an exemplary embodiment. The vehicle 10 can include one or more seat assemblies 12 provided for an occupant of the vehicle 10. While the vehicle 10 shown is an automobile, it should be understood that the seat 12 may be used in any type of vehicle used to accommodate a seated occupant, including a passenger vehicle, train, airplane, boat or any other means in or by which someone travels or something is carried or conveyed.

Referring now to FIG. 2, a seat assembly 12 is shown. The seat 12 illustrated is a occupant seat typically used in front row of a vehicle, but the seat structures of the present disclosure may be incorporated into any vehicle seat, such as a second row seat, a second row bench, a third row, or the like, which may utilize any type of seat functionality. Further, the seat assembly 12 could also be utilized as a stand-alone seat assembly, such as for an office seat, theatre seat or any other contemplated use of a seat.

The seat assembly 12 includes a seat back 14 operatively connected to a seat base 16. The seat back 14 and seat base 16 includes a seat frame 28 and a seat cover 24 overlying the seat frame 28. A padding (not shown) may be disposed between the seat frame 28 and seat cover 24 to provide a desired shape and support to the seat. The seat base 16 may include a seat cushion 26, The seat back 14 and seat cushion 26 provide comfort, support and protection to a seated occupant (not shown). The seat 12 may also include a head restraint 18 positioned at an upper end of the seat back 14, and operatively connected thereto. The head restraint 18 extends upwardly from the seat back 14 and is configured to provide support and restrain the head of an occupant. The seat back 14 may be pivotally coupled to the seat base 20 via an actuator 20, such as a recliner mechanism, that provides rotatable adjustability between the seat back 14 and the seat base 16. The seat assembly 12 can also be secured to the vehicle 10 using a track assembly 22. In this example, the track assembly 22 enables the seat assembly 12 to be repositioned relative the vehicle floor to enhance comfort and utility.

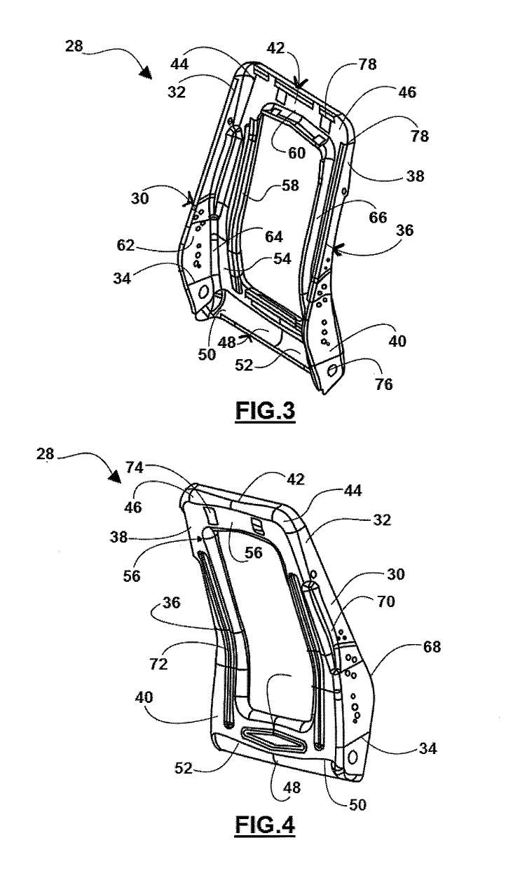

Referring to FIGS. 3 and 4, the seat back 14 includes a one-piece seat back frame 28. The one-piece back frame 28 is stamped from a single piece of material and includes an integrally formed slip plane. The one-piece back frame 28 includes a generally planar first member, which in this example is a first side member 30 having an upper end 32 and lower end 34. The one-piece back frame 28 includes an opposed generally planar second member or second side member 36 of this example having an upper end 38 and lower end 40. The one-piece seat back frame 28 also includes a generally planar third member or upper cross member 42 in this example having a first end 44 and an opposed second end 46. The upper cross member 42 is located between the upper end of first side member 32 and the upper end of the second side member 38. The one-piece back frame 28 further includes an opposed, generally planar fourth member, which in this example is a lower cross member 48 having a first end 50 and a second end 52, and is disposed between the lower end of the first side member 34 and the lower end of the second side member 40. The first side member 30, the second side member 36, the upper cross member 42 and lower cross member 48 are integrally formed as a substantially rectangular one-piece back frame 28. The one-piece back frame 28 has a front surface 54 and a rear surface 56. The front and rear surfaces 54, 56 respectively may have a substantially flat contour, but may also include have a variety of localized profiles, contours, features, or the like, as needs or performance requirements dictate.

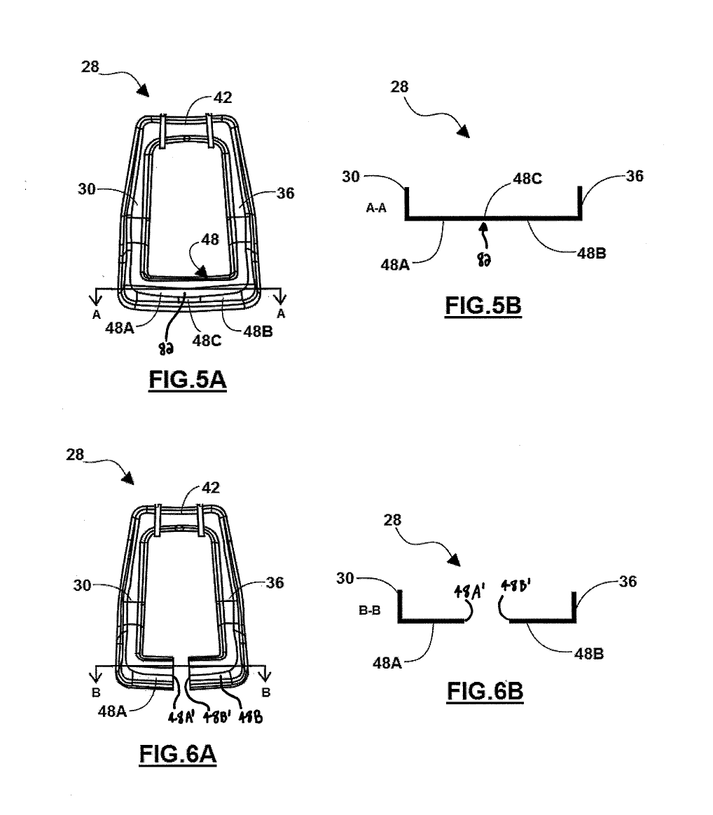

The one-piece seat back frame 28 also includes an extended portion, as shown at 29 that is intentionally over-sized a predetermined dimension with respect to a predetermined finished dimension. The extended portion 29 forms an integral slip plane to facilitate manufacturing and customization in a manner to be described. For example, as shown in FIG. 5A, the lower cross member 48 may include an initial over-sized portion 29 having a predetermined initial dimension, which in this example is the overall length, forming a first portion 48A, a second portion 48B, and a third portion 48C extending therebetween the first portion 48A and second portion 48B. The third portion 48C can later be cut or excised from the lower cross member later (such as, downstream in the manufacturing process, or the like) to facilitate the method of forming and customizing the one-piece seat back frame 28 as will be described in further detail below. In another example, the third portion or segment 48C can be in the form of a tab that interconnects the first portion 48A and the second portion 48B, and which can be cut or removed at some predetermined point later during the process, such as, during stamping, during assembly, during manufacturing, or the like.

The one-piece back frame 28 may also include an inner side wall 58 extending circumferentially around a portion of an inner edge 60 of the front surface 54. The one-piece seat back frame 28 may also include an outer side wall 62 extending circumferentially around a portion of the outer edge 64 of the front surface 54 to cooperatively form and define a generally U-shaped channel 66, The one-piece back frame 28 can also have an over-sized portion forming an angled portion 68 that is located in either one of the first side member 32 or second side member 36. In this example, the angled portion 68 is located nearer the lower cross member 48.

The one-piece back frame 28 may include a feature such as a lower cross bracket member, pivot bracket, recliner, or the like, can also include a surface features or structure 70, such as, ribs/stiffeners, beads, darts, protrusions, elevations, depressions, deformations, stampings, openings, or the like. Such surface features 70 may be formed as part of or integral with the back frame 28 to enhance the strength and rigidity performance of the seat back frame 28 without significantly increasing the mass thereof. The number, length, shape, width, dimensions, position, location, orientation, or the like, of the surface features 70 can vary as appropriate and/or as needed to optimize strength, stability and performance of the one-piece back frame 28. In this example, a vertically extending rib 72 is formed in a portion of each of the first side member 30 and second side member 36 to enhance the fore/aft stiffness of the one-piece back frame 28. The complexity of these features 70 can vary depending on the type of material used for the one-piece back frame 28. Generally, the complexity of the geometries may be increased with the use of lower strength material. The one-piece back frame 28 may also include a plurality of openings 74, such as, holes, extruded holes, apertures, grooves, channels, passageways, or the like, and interface/surface areas 76 for attachment of other components, such as, recliner mechanisms, recliner plates, recliner shafts, foam, trim covers, head restraints, or the like. The one-piece back frame 28 may also include a plurality flanges 78 extending from the inner and outer side walls 58, 62 that provide stiffness to the structure, durability for the seat foam/upholstery, reduced sharp edges, and attachment/resting surfaces for other components, such as, foam, trim cover, or the like.

The one-piece seat structure can be formed from various materials, such as, tailor welded blanks, tailor welded coils, monolithic blanks or coils having uniform or non-uniform material grade and thickness, or the like. The one-piece seat structures can be formed from a variety of steel grades and types, such as, HSLA, AHSS (Dual Phase, Complex Phase, TRIP, post form heat treatable steel, such as, aluminum, magnesium, or the like). The materials used can be optimized depending on various factors, such as, the type of structure or portion to be made, the location of the structure or portion, the geometry requirements of the structure or portion, the strength requirements of the structure or portion, or the like. For example, lower strength materials typically have higher formability which enable incorporation of more (or higher complexity) geometry in the design of a structure or portion, but may require greater thickness to recover strength lost by using lower strength material. The formability and strength of the material can be optimized and balanced according to the needs dictated by the type of structure or portion and its location within the seat assembly.

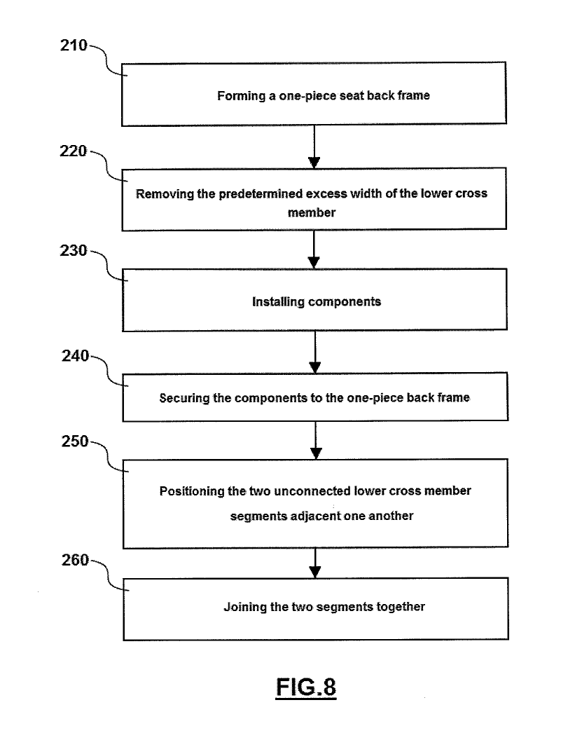

Referring now to FIG. 8, a method of forming and customizing the one-piece seat back frame 28 of FIGS. 2-7 is shown. The method begins at Step 210 whereby a one-piece seat back frame 28 is formed. The one-piece seat back frame 28 may be formed using any forming process, such stamping. The one-piece seat back frame 28 includes a lower cross member 48 that initially has an over-sized portion 29 with an integrally formed slip plane 29. While in this example the over-sized, portion 29 is in the lower cross member, the over-sized portion could be formed in any of the members of the one-piece seat back frame 28. The excess material 48c is greater than the final or finished dimension of the lower cross member, in terms of length, width, or the like, as shown in FIG, 5A and 5B. For example, the lower cross member 48 can have an initial predetermined excess length of 5 to 10 mm.

The method proceeds to Step 220 wherein the portion of excess material 48C is removed from the lower cross member 48, such as via a cut, or the like, such as during stamping, as shown in FIG. 6A and 6B. To facilitate this step, the one-piece back frame 28 can be positioned into a fixture, such as a fixture for welding secondary components thereto, or the like. Once in the fixture, the portion of excess material 48C can be removed using a predetermined excision technique, such as laser cutting, stamp cutting, die cutting, or the like. Once the portion of excess material 48C is cut, the first portion 48A and the second portion 48B are disconnected and separated, and each have a free edge, 48A′ and 48B′ respectively. The separation between the first portion 48A and second portion 48B, enables the first portion 48A and the second portion 48B to be independently manipulated, maneuvered, adjusted, or the like. This freedom of movement thereby facilitates attachment of other components to the one-piece seat structure, such as a recliner mechanism, or the like.

The method proceeds to Step 230 wherein additional components, such as recliner mechanisms, or the like, are subsequently attached to the one-piece seat back frame 28 during assembly. In this example, a recliner mechanism is attached to the lower cross member first portion 48A and another recliner mechanism is attached to the lower cross member second portion 48B. The attachment may be semi-permanent, so that the relative orientation of the additional component may be adjusted.

The method proceeds to Step 240 wherein the additional component is permanently secured to the one-piece seat back frame 28. The component, such as a recliner mechanism, may be secured to the one-piece seat back frame 28 using a predetermined technique such as welding, fastening, bolting, screwing, or the like.

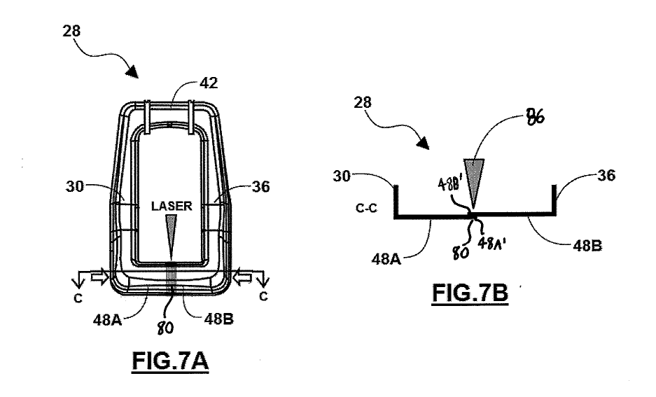

The method proceeds to Step 250 wherein the first portion 48A and the second portion 48B are adjusted and rejoined, and the first portion edge 48A′ and second portion edge 48B′ are properly aligned with one another in a predetermined manner. For example, the first portion 48A and the second portion 48B can be repositioned adjacent to one another such that a portion of the first portion and the second portion overlap one another, as shown in FIG. 7A and 7B at 80.

The method proceeds to Step 260 wherein the overlapped portion 80 of the first portion 48A and the second portion 48B are secured together using a predetermined joining technique, such as welding, fastening, bolting, screwing, or the like. In this example, the first portion 48A and the second portion 48B are laser welded together.

The one-piece may be finished in a finishing operation. For example, additional steps can be performed to further customize the one-piece seat back frame. Additional components can be attached to the one-piece seat back frame, such as reinforcement brackets, head restraint components, or the like. Also, surface features can be created, such as ribs for added strength and rigidity, cutting openings for attachments, or the like. It should be noted that while this example a lower cross member includes an over-sized portion, the method can be used with a frame 28 having other over-sized portions or multiple over-sized portions, such as an upper cross member, side member, or the like. Moreover, the method can be modified in various manners, such as by adding one or more steps, removing one or more steps, changing the sequence of the steps, or the like.

Many modifications and variations of the present disclosure are possible in light of the above teachings. Therefore, within the scope of the appended claim, the present disclosure may be practiced other than as specifically described.

What is claimed is:

1. A one-piece seat back frame for use in a seat assembly, the one-piece seat back frame comprising:
a first member and an opposed second member spaced a predetermined distance from the first member;
a third member extending between and integrally joined to the first member and second member; and
a fourth member spaced a predetermined distance from the third member and extending between and integrally joined to the first member and second member, wherein the fourth member has an initial predetermined dimension that is over-sized a predetermined amount to form an excisable portion, and a final predetermined dimension after the excisable portion is removed and free ends rejoined, so that the one-piece seat back frame can be adjusted prior to rejoining the free ends.

2. The one-piece seat back frame of claim 1, wherein the first member is a first side member, the second member is a second side member, the third member is an upper cross member and the fourth member is a lower cross member, and the first side member, second side member, third upper cross member and fourth lower cross member are initially formed as an integral, one-piece frame.

3. The one-piece seat back frame of claim 1, wherein the fourth member includes a first portion, a second portion and a third portion extending between the first portion and second portion and the third portion is excised to form a slip plane for adjusting the seat one-piece seat back frame.

4. The one-piece seat back frame of claim 1, wherein the third portion is a tab.

5. The one-piece seat back frame of claim 1, further comprising a component attached to the one-piece seat back frame after the excisable portion is removed and before the free ends are rejoined, and the free ends of the fourth member are adjusted to accommodate the component with respect to the one-piece seat back frame and then rejoined.

6. A one-piece seat back frame for use in a seat assembly, the one-piece seat back frame comprising:
a first side member and an opposed second side member spaced apart from the first member;
an upper cross member extending between and integrally joined to the first side member and second side member; and
a lower cross member spaced apart from the upper cross member and extending between and integrally joined to the first side member and second side member, wherein the lower cross member has an initial predetermined dimension that is over-sized a predetermined amount to form an excisable portion, and a final predetermined dimension after the excisable portion is removed and free ends rejoined, so that the one-piece seat back frame can be adjusted prior to rejoining the free ends.

7. The one-piece seat back frame of claim 6, wherein the lower cross member includes a first portion, a second portion and a third portion extending between the first portion and second portion and the third portion is excised to form a slip plane for adjusting the seat one-piece seat back frame.

8. The one-piece seat back frame of claim 7, wherein the middle portion is a tab.

9. The one-piece seat back frame of claim 6, further comprising a component attached to the one-piece seat back frame after the excisable portion is removed and before the free ends are rejoined, and the free ends of the lower cross member are adjusted to accommodate the component with respect to the one-piece seat back frame and then rejoined.

10. A method of forming a one-piece seat back frame for a vehicle, the method comprising the steps of:
(a) providing a one-piece seat back frame including a first member, an opposed second member, a third member extending between and integrally joined to the first member and second member and a fourth member spaced a predetermined distance from the third member and extending between and integrally joined to the first member and second member, wherein the fourth member has an initial predetermined dimension that is over-sized a predetermined amount to form an excisable portion;
(b) removing the excisable portion from the fourth member;
(c) attaching a component to the one-piece seat back frame;
(d) adjusting the one-piece seat back frame to align the component by manipulating the free ends of the fourth member; and
(e) rejoining the free ends of the fourth member, wherein the fourth member has a final predetermined dimension after free ends are rejoined.

11. The method of claim 10, wherein the component is a first recliner mechanism.

12. The method of claim 10, wherein the first member is a first side member, the second member is a second side member, the third member is an upper cross member and the fourth member is a lower cross member, and the first side member, second side member, third upper cross member and fourth lower cross member are initially formed as an integral, one-piece frame.

13. The method of claim 10, wherein the fourth member includes a first portion, a second portion and a third excisable portion extending between the first portion and second portion that is excised to form a slip plane.

14. The method of claim 12, wherein the third excisable portion is a tab.

15. The method of claim 10, further comprising the step of overlapping the free ends of the fourth member, so that a final predetermined length of the fourth member is less than an initial predetermined length of the fourth member.
